(19) United States
(12) Patent Application Publication
(10) Pub. No.: US 2012/0137295 A1
(43) Pub. Date: May 31, 2012

(54) METHOD FOR DISPLAYING CPU UTILIZATION IN A MULTI-PROCESSING SYSTEM

(75) Inventors: Joseph L. Soetemans, Ottawa (CA); Neel Jatania, Ottawa (CA)

(73) Assignee: Alcatel-Lucent Canada Inc., Ottawa (CA)

(21) Appl. No.: 12/956,972

(22) Filed: Nov. 30, 2010

(51) Int. Cl. G06F 9/46; G06F 3/048

(52) U.S. Cl. 718/100; 715/772

(57) ABSTRACT

Various exemplary embodiments relate to a method of measuring CPU utilization. The method may include: executing at least one task on a multi-processing system having at least two processors; determining that a task is blocked because a resource is unavailable; starting a first timer for the task that measures the time the task is blocked; determining that the resource is available; resuming processing the task; stopping the first timer for the task; and storing the time interval that the task was blocked. The method may determine that a task is blocked when the task requires access to a resource, and a semaphore indicates that the resource is in use. The method may also include measuring the utilization time of each task, an idle time for each processor, and an interrupt request time for each processor. Various exemplary embodiments relate the above method encoded as instructions on a machine-readable medium.

### TECHNICAL FIELD

Various exemplary embodiments disclosed herein relate generally to CPU utilization in multi-processing computer systems.

### BACKGROUND

Computer users often wish to monitor the performance of their computer system. Most operating systems can run a diagnostic program that shows how the computer is using various resources. For example, an operating system can usually display a list of tasks or processes running on the computer along with quantities of resources consumed. Typical programs may display the memory and CPU percentage used for each task and a CPU idle percentage. The computer user can use this information to judge, for example, whether the computer has enough resources to run another task or whether a certain task is consuming too many resources.

A multi-processing computer system is a computer system with more than one processor that can run tasks. A multi-processing system may have a plurality of processors each on a separate chip. A multi-processing system may also include a multi-core system in which a plurality of processors (cores) are located on a single chip or single die. The term processor may refer to either a stand-alone processor on its own chip or to one core of a multi-core processor. In a multi-core system, the processors may share various resources such as, for example, a system bus, cache, memory, drive, device, port, etc.

Existing methods of monitoring CPU utilization were designed for computer systems with a single processor. On a system with a single processor, a CPU utilization percentage provides a useful indication of how much each task is using the processor. A system idle percentage is a useful indication of how much remaining processor time is available. These statistics, however, are not as useful on a system with multiple processors or a system with multiple cores. A CPU utilization percentage will often indicate that a task is using only a small percentage of the CPU; however, there may be no more resources available to that task. Furthermore, a high idle time may indicate that the system is not busy even when an individual core is running at full capacity.

In view of the foregoing, it would be desirable to provide a method of monitoring CPU utilization in a multi-processing system. In particular, it would be desirable to provide meaningful statistics that allow a user to accurately judge the status of the system. The statistics should allow the user to determine whether additional resources are available and whether any tasks or cores are running at full capacity.

### SUMMARY

In light of the present need for a method of monitoring CPU utilization in a multi-processing system, a brief summary of various exemplary embodiments is presented. Some simplifications and omissions may be made in the following summary, which is intended to highlight and introduce some aspects of the various exemplary embodiments, but not to limit the scope of the invention. Detailed descriptions of a preferred exemplary embodiment adequate to allow those of ordinary skill in the art to make and use the inventive concepts will follow in later sections.

Various exemplary embodiments relate to a method of measuring CPU utilization. The method may include: executing at least one task on a CPU; determining that a task is blocked because a resource is unavailable; starting a first tinier for the task that measures the time the task is blocked; determining that the resource is available; resuming processing the task; stopping the first timer for the task; and storing a blocked time indicating the amount of time the task was blocked. The method may determine that a task is blocked when the task requires access to a resource that is controlled by a semaphore and the semaphore indicates that the resource is in use. The method may also include starting a second timer that measures the utilization time of the task when the processor begins executing the task; stopping the second timer when the task is blocked; and determining a load time by adding the time that the task was blocked and the utilization time. Additionally, the method may include measuring an idle time for each processor; measuring an interrupt request time for each processor; selecting a processor that has the lowest idle time; selecting a processor that has a greatest interrupt request time; and determining a busiest processor from the processor that has the lowest idle time and the processor that has the greatest interrupt request time. Various exemplary embodiments relate to the above method encoded as instructions on a machine-readable medium.

Various exemplary embodiments relate to a multi-processing system. The multi-processing system may include: at least two processors that execute tasks; at least one semaphore that indicates whether a resource is available; a first timer for each task that measures the time that the task is blocked by starting when the semaphore indicates that a resource is unavailable and stopping when one of the processors begins executing the task; a second timer for each task that measures a utilization time for the task by starting when one of the processors begins executing the task and stops when the semaphore indicates that a required resource is unavailable; and an output device that indicates a load percentage for each task based on the sum of the time that the task is blocked and the time that the task is running. The multi-processing system may also include a third timer for each processor that measures idle time of the processor and determines an idle percentage and a fourth timer for each processor that measures the interrupt request time of each processor.

It should be apparent that, in this manner, various exemplary embodiments enable a method of monitoring CPU utilization in a multi-processing system. In particular, by measuring the utilization time, blocked time, interrupt request time, and idle time the method can provide meaningful statistics that allow a user to accurately judge the status of the system. The statistics may allow the user to determine whether additional resources are available and whether any tasks or cores are running at full capacity.

### BRIEF DESCRIPTION OF THE DRAWINGS

In order to better understand various exemplary embodiments, reference is made to the accompanying drawings, wherein:

FIG. 1 illustrates a schematic diagram of an exemplary multi-processing system;

FIG. 2 illustrates an exemplary data structure for storing CPU measurements for tasks;

FIG. 3 illustrates an exemplary data structure for storing CPU measurements for cores;

FIG. 4 is a flowchart illustrating an exemplary method for measuring CPU utilization in a multi-processing system;

FIG. 5 is a flowchart illustrating an exemplary method for determining the load on a busiest processor in a multi-processing system;

FIG. 6 is a flowchart illustrating an exemplary method for determining the load percentage for each task running on a multi-processing system; and

FIG. 7 is a diagram illustrating an exemplary display for communicating CPU utilization to a user.

### DETAILED DESCRIPTION

Referring now to the drawings, in which like numerals refer to like components or steps, there are disclosed broad aspects of various exemplary embodiments.

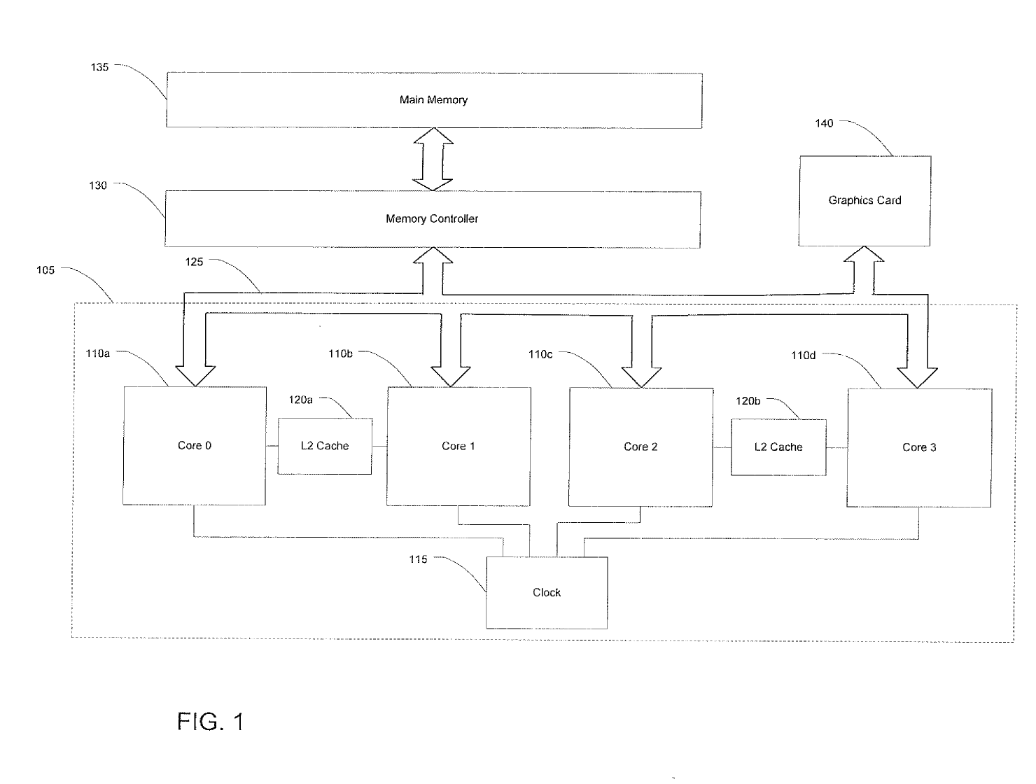

FIG. 1 illustrates a schematic diagram of an exemplary multi-processing system 100. Multi-processing system 100 may include Central Processing Unit (CPU) 105, bus 125, memory controller 130, main memory 135, and graphics card 140. Multi-processing system 100 may also include numerous other components such as, for example, cards, drives, ports, power supplies, etc. The components of multi-processing system 100 may be embedded within, inserted into, or otherwise coupled to a motherboard. Multi-processing system 100 may be embodied in a variety of computer systems. For example, multi-processing system 100 may be a personal computer, laptop, server, router, switch, or any other computer system.

CPU 105 may be the central processing unit of the multi-processing system 100. CPU 105 may execute the instructions of computer programs. As will be described in further detail below, CPU 105 may include a plurality of processors or cores. Although an individual processor or core may actually execute the instructions of computer programs, CPU 105 may be described as executing the instructions when it is indeterminate which processor or core actually carries out the instruction. CPU 105 may take a variety of forms and is not limited to the particular embodiment shown. For example, CPU 105 may be a single chip or a plurality of interconnected chips. CPU 105 may also be formed on a single die or a plurality of dies within a chip package. CPU 105 may use hyper threading to make a single core appear as a plurality of cores. CPU 105 may include: a plurality of cores 110, clock 115, and one or more L2 caches 120. CPU 105 may also include an L3 cache (not shown). CPU 105 may be coupled to multi-processing system 100 via bus 125.

The plurality of cores 110 may be a plurality of processors. Each individual core 110 may process computer instructions. Generally, one core from among the plurality of cores 110 may be assigned to process the instructions for an individual task. Other tasks may be executed by the same core or any of the other cores 110. Each core may include an arithmetic and logic unit (ALU), program counter, L1 cache, and any other components necessary to execute tasks. Each core may be formed on its own die, or several cores may be formed on the same die. A number may be assigned to each core to identify it within multi-processing system 100. In the example shown in FIG. 1, four cores 110a-d are used. Core 110a may be identified as core 0. Core 110b may be identified as core 1. Core 110c may be identified as core 2. Core 110d may be identified as core 3.

Clock 115 may provide a clock signal to each core 110. The clock signal may be used by the cores to synchronize processing of instructions. Cores 110 may measure time in units of the clock signal or convert the time into standard units. Clock 115 may also provide a system time to each core 110 that may be used to mark the time that the core begins or ends processing of a task.

L2 cache 120 may be a memory location such as, for example, a memory bank of registers. L2 cache 120 may be a single bank of cache memory or may be divided. In the exemplary system shown in FIG. 1, there are two L2 caches 120a and 120b. Each L2 cache 120 may be shared by two cores.

Bus 125 may be a standard system bus for a multi-processing system. Bus 125 may carry data from each core 110a-d within CPU 105 to the other components of multi-processing system 100. For example, Bus 125 may connect CPU 105 with memory controller 130 and main memory 135. Additional components such as, for example, graphics cards, I/O slots, ROMs, hard drives, Ethernet cables, etc. may also be coupled to Bus 125. Bus 125 may be shared among the plurality of cores 110.

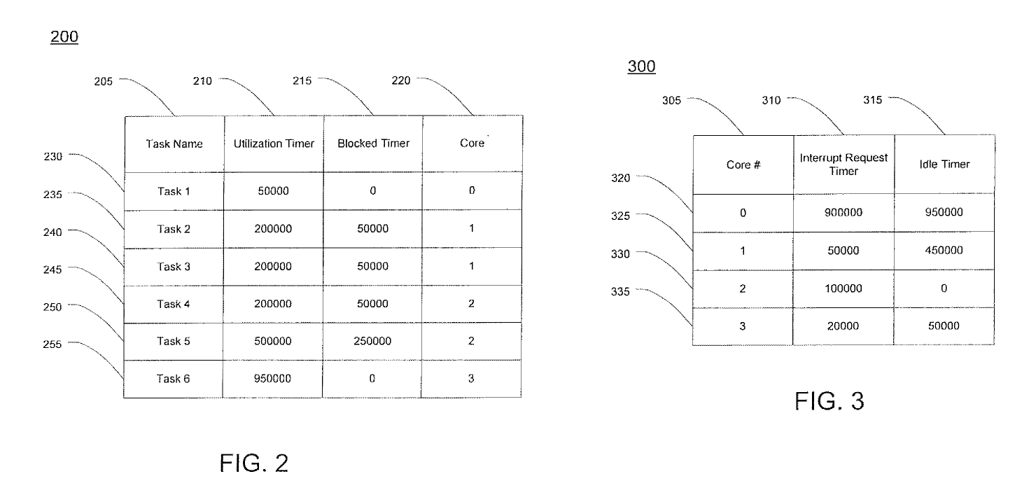

Memory controller 130 may be a circuit that controls access to main memory 135. Main memory 135 may store program instructions or data. Main memory 135 may send information to CPU 105 via memory controller 130 and bus 125. Main memory 135 may be used to create timers such as, for example, test timers, utilization timers, blocked timers, interrupt request timers and idle timers. Main memory 135 may also store timer results and any other data that is useful for measuring CPU utilization. The exemplary data structures illustrated by FIG. 2 and FIG. 3 may be stored in main memory 135. As will be described in greater detail below, a semaphore may be used to control access to various resources such as, for example, software blocks and data structures stored in main memory 135. Additional semaphore applications will be apparent to those of skill in the art.

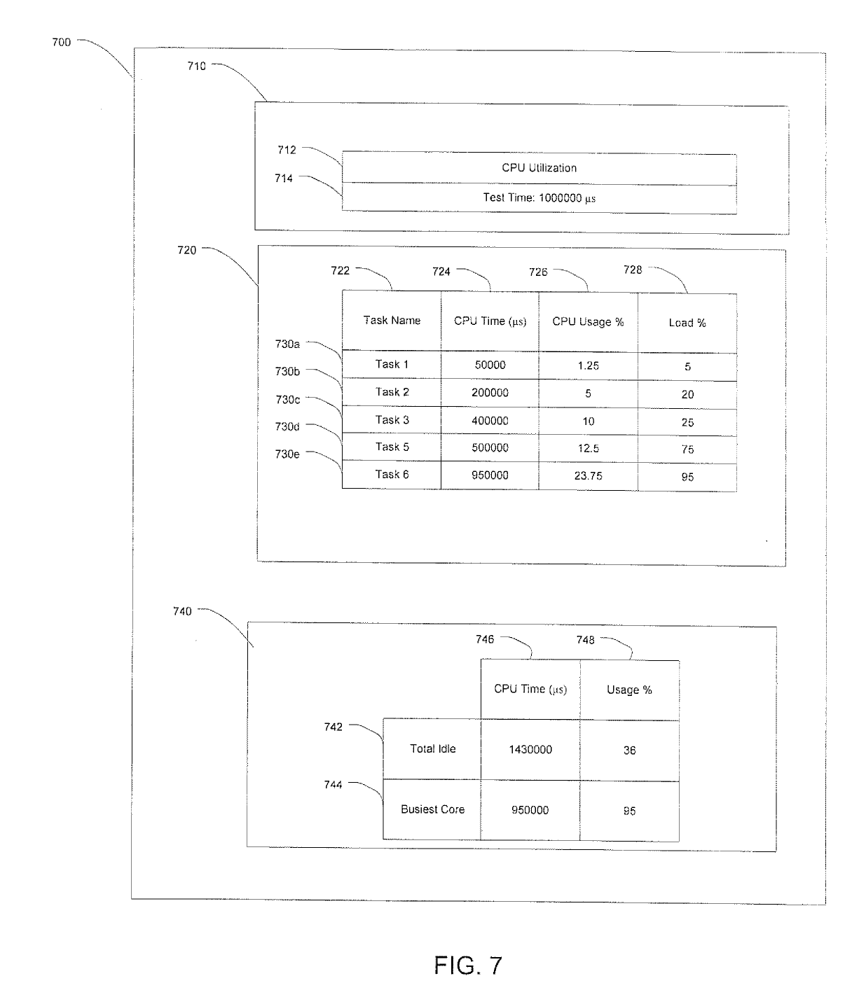

Graphics card 140 may be an output device that generates output images to a display. Graphics card 140 may be connected to bus 125 and receive computer instructions or data from other components of multi-processing system 100. Graphics card 140 may also be connected to a device such as a computer monitor. Graphics card 140 may generate images such as, for example, the exemplary display shown in FIG. 7. A semaphore may be used to control access to graphics card 140 to prevent multiple cores from attempting to access graphics card 140 at the same time. System 100 may include additional output devices such as, for example, a communications port, network card, or any other method of communicating information.

FIG. 2 illustrates an exemplary data structure 200 for storing CPU measurements for tasks. Data structure 200 may include fields for task name 205, utilization timer 210, blocked timer 215, and core number 220. Task name field 205 may store a string that indicates a name for each running task or any other value that uniquely identifies the task. For example, task name field 205 may store the name of the executable file or a process identifier as the task name. Utilization timer field 210 may store the utilization time for each task. In various alternative embodiments, utilization timer field 210 may store additional information such as the cumulative utilization time, last utilization start time and an indication of whether the task is currently running. Blocked timer field 215 may store the blocked time for a current task. In various alternative embodiments, blocked timer field 215 may store additional information such as the cumulative blocked time, last blocked start time and an indication of a semaphore for which the task is waiting, if any. Core number field 220 may store an identifier of the core that is executing the task. In various alternative embodiments, where a task may run on more than one core, each entry for utilization timer 210 and blocked timer 215 may store a utilization time and blocked time for each core. In these alternative embodiments core number field 220 may not be present.

Data structure 200 may include a plurality of entries 230, 235, 240, 245, 250, and 255. Each entry may include data for the task name 205, utilization timer 210, blocked timer 215 and core number 220. The data within data structure 200 may be updated frequently to reflect the ongoing use of CPU 105 to execute tasks. Data structure 200 may be reset at a regular test interval to set utilization timer field 210 and blocked timer field 215 to zero. Although data structure 200 is shown as a table for convenience, alternative data structures such as, for example, linked lists or trees may be used. As an example, entry 230 may indicate that “Task 1” has run on core 0 for 50,000 μs and has spent no time blocked. Entries 235-255 indicate similar information for additional tasks 2-6.

FIG. 3 illustrates an exemplary data structure 300 for storing CPU measurements for cores. Data structure 300 may include fields for core number 305, interrupt request timer 310, and idle timer 315. Core number 305 may store an identifier to indicate to which of the cores the data applies. Interrupt request timer field 310 may store the time each core spends handling interrupt requests. In various alternative embodiments, interrupt request timer field 310 may store additional information such as the cumulative interrupt request time, last interrupt start time and an indication of whether core is handling an interrupt. Idle timer field 315 may store the time that each core spends idle. Alternatively, idle time may be treated as a task for each core and the idle time may be stored in data structure 200 as the utilization time of each idle task.

Data structure 300 may include a plurality of entries 320, 325, 330, and 335. Generally data structure 300 may contain one entry for each core 110. Each entry may include data for the core number field 305, interrupt request timer field 310, and idle timer field 315. The data within data structure 300 may be updated frequently to reflect the ongoing use of CPU 105 to execute tasks and handle interrupts. Data structure 300 may be reset at a regular test interval to set interrupt request timer field 310 and idle timer field 315 to zero. Although data structure 300 is shown as a table for convenience, alternative data structures such as, for example, linked lists or trees may be used. As an example, entry 320 may indicate that core 0 has spent 900,000 μs processing interrupt requests and 950,000 μs in an idle state. Likewise, entries 325-335 indicate similar statistics for cores 1-3. It should be noted interrupt requests may occur while a core is processing tasks or during an idle task. At least a portion of time spent processing interrupts may be reported as both interrupt request time and utilization time or idle time, producing values that may add up to greater than the test time. In various alternative embodiments, interrupt request time may be subtracted from the utilization time of the interrupted task or idle time in order to prevent double counting of the interrupt request time.

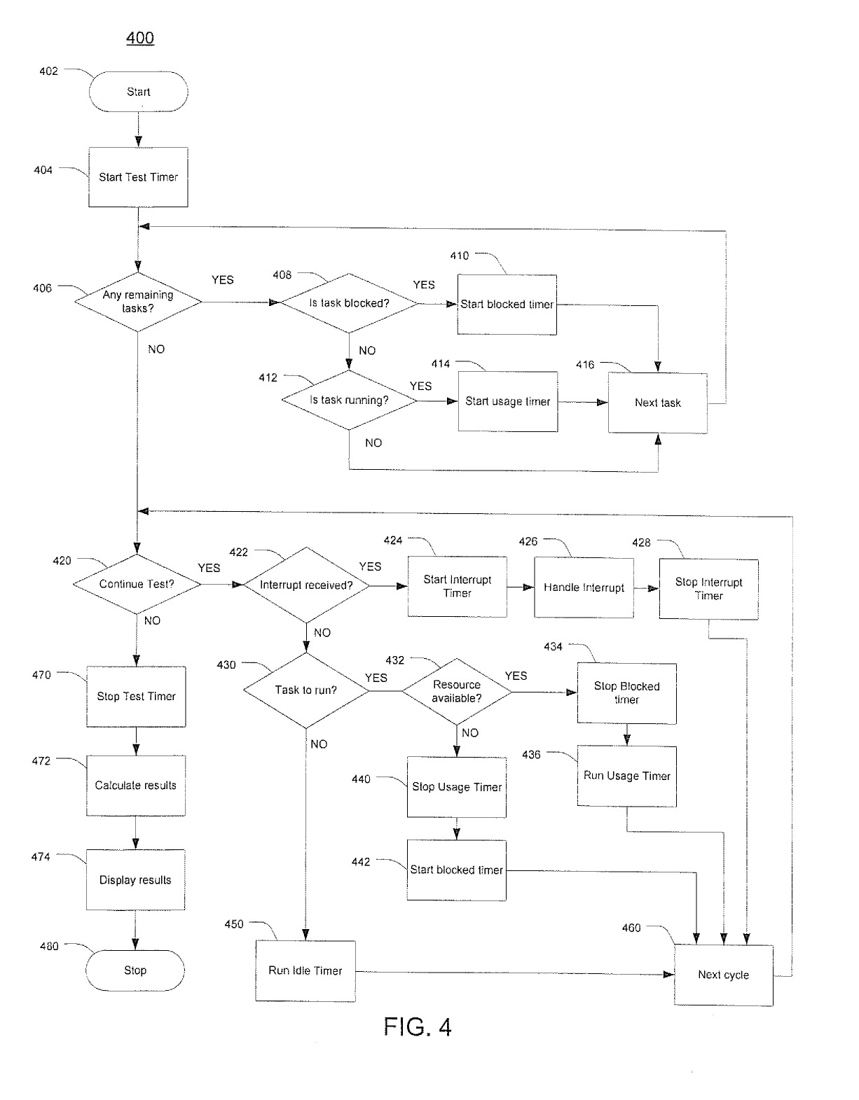

FIG. 4 is a flowchart illustrating an exemplary method 400 for measuring CPU utilization in a multi-processing system. Method 400 may be performed by the components of multi-processing system 100 to measure the CPU utilization of multi-processing system 100. Multi-processing system 100 may use hooks to indicate when particular events have occurred. For example, a hook may indicate when CPU 105 or a core 110a-d swaps tasks. CPU 105 may perform the various steps of method 400 in response to events indicated by hooks. It should be understood that multi-processing system 100 may execute multiple tasks in parallel and that various steps of method 400 may occur simultaneously. A person having ordinary skill in the art will recognize other appropriate techniques for implementing method 400.

Method 400 may begin at step 402 and proceed to step 404 where CPU 105 may start a test timer. It should be apparent that any method known in the art for timing processors may be used as a test timer. For example, CPU 105 may store a system time for the start of the system test in a memory location. Alternatively, CPU 105 may initialize a counter to measure the test period or use a timing circuit. The test timer may be reset whenever a test finishes for continuous monitoring of the CPU utilization. The method may then proceed to step 406 where the CPU 105 begins the process of initializing timers for each task. In step 406, the CPU 105 determines whether there are any remaining tasks to initialize. If there are remaining tasks for which CPU 105 has not initialized timers, the method 400 may proceed to step 408. If there are not any remaining tasks, the initialization may be complete and the method may proceed to step 420.

In step 408, CPU 105 may determine whether the current task is blocked. CPU 105 may determine that a task is blocked if the task is waiting for a resource. Multi-processing system 100 may share resources between tasks using a semaphore to indicate that the resource is in use. If a task is waiting for a semaphore before continuing processing, CPU 105 may determine that the task is blocked. In some situations, however, CPU 105 may not always determine that a task is blocked when it is waiting for a semaphore. If a task includes a timeout for waiting on the semaphore, the task may not be blocked because it may run again when the timeout expires. CPU 105 may determine that a task is not blocked if the task includes a timeout for waiting on the semaphore. CPU 105 may determine that a task is blocked when waiting for a binary or a mutex semaphore, but may determine that a task is not blocked if waiting for other types of semaphore. In various exemplary embodiments, CPU 105 may determine that a task is blocked if the task meets three criteria: 1) the task is waiting for a semaphore owned by another task; 2) the task will wait forever to acquire the semaphore; and 3) the semaphore is either a binary or mutex semaphore. CPU 105 may determine that the task will wait forever to acquire the semaphore if there is no timeout on waiting for the semaphore. In various alternative embodiments, the criteria may include additional semaphore types or other means of exclusion. In various alternative embodiments, a task may be blocked if the task will wait for a long time rather than forever. CPU 105 may determine that a task will wait for a long time if a timeout on the semaphore exceeds a system timeout threshold. The system timeout threshold may be system dependant. For example, the system timeout threshold may be based on the longest timer required by the system. If the current task is blocked, the method may proceed to step 410. If the task is not blocked, the method may proceed to step 412.

In step 410, CPU 105 may start a blocked timer for the task. CPU 105 may store the system time in a memory location for the task. For example, if the current task is “Task 1,” CPU 105 may store the current system time as entry 230 in the blocked timer 215 field of data structure 200. CPU 105 may take other actions to initialize the timers for the current task such as, for example, resetting any accumulated blocked or utilization time and setting flags to indicate the status of the current task. The method may then proceed to step 416.

In step 412, CPU 105 may determine whether the current task is presently running on the core. If the task is running on the core, the method may proceed to step 414. If the task is not running on the core, the method may proceed directly to step 416. In the case where a task is not blocked as determined in step 408 and not running as determined in step 412, CPU 105 may initialize the blocked timer and utilization timer of the task to zero before proceeding to step 416.

In step 414, CPU 105 may start a utilization timer for the current task. CPU 105 may store the system time in a memory location for the task. For example, if the current task is “Task 2,” CPU 105 may store the current system time as entry 235 in utilization timer field 210 of data structure 200. CPU 105 may take other actions to initialize the timers for the current task such as, for example, resetting any accumulated blocked or utilization time and setting flags to indicate the status of the current task. The method may then proceed to step 416. In step 416, CPU 105 may move to the next task. The method 400 may then return to step 406 to continue initializing the timers.

In step 420, CPU 105 may determine whether to continue the test. CPU 105 may compare the test timer with a test interval. If the test timer indicates that the test interval has not finished, the test may continue. If the test continues, the method 400 may proceed to step 422. If the test does not continue, the method may proceed to step 470.

In step 422, CPU 105 may determine whether multi-processing system 100 has received an interrupt request. Interrupt requests may arrive for a variety of reasons such as, for example, keyboard or mouse input, port communications, device activity, etc. In a multi-processing system, one or more processors may handle incoming interrupt requests. Step 422 may occur simultaneously as each core 110 determines whether it has received an interrupt request. In various embodiments, a single processor may first receive each incoming interrupt request then determine which processor should handle the interrupt. If a core 100 has received an interrupt request, the method 400 may proceed to step 424. If there is no interrupt request, the method may proceed to step 430.

In step 424, the core 110 that received the interrupt request may start an interrupt timer. The core 110 may store the system time of the interrupt request in a memory location for the core. For example, if core 110a receives an interrupt request, core 110a may record the system time as entry 320 in interrupt request timer 310 field of data structure 300. The method 400 may then proceed to step 426 where the core 110 may handle the interrupt request. It should be noted that another task may be running on core 110 when the interrupt request is received. In this case, the other task may be considered an interrupted task. CPU 105 may refrain from adjusting the utilization timer 210 or blocked timer 215 of the interrupted task. Alternatively, CPU 105 may stop the utilization timer for the interrupted task. Core 110 may execute program instructions based on the type of the interrupt request. Core 110 may determine that the interrupt request relates to a task running on a different core and pass any data received with the interrupt request to the appropriate core. Once core 110 has handled the interrupt, the method may proceed to step 428 where core 110 may stop the interrupt timer. When core 110 stops the interrupt timer, it may compare the current system time with the system time stored in the appropriate entry of interrupt request timer 310 to determine the duration of the interrupt. Core 110 may then add the duration of the interrupt to a cumulative interrupt time for the core 110. The method 400 may then proceed to step 460.

In step 430, CPU 105 may determine whether there is a task to run. CPU 105 may consider running tasks, blocked tasks, or waiting tasks in step 430. If a core 110 has multiple tasks to run, the core 110 may determine which task to run based on priority. If core 110 swaps tasks, core 110 may stop the utilization timer 210 for the old task and start the utilization timer 210 for the new task. Core 110 may also stop an idle timer 315 that is running for the core when it starts running a new task. Step 430 may be performed simultaneously at each core 110. If a core 110 determines that there is a task to run, the method 100 may proceed to step 432. If a core 110 determines that there is no task to run, the method 100 may proceed to step 450. It should be understood that some cores 110 may have tasks to run while others do not. Method 400 may operate in parallel for each core.

In step 432, core 110 may determine whether a required resource is available. As described above with regard to step 408, core 110 may check semaphores to determine whether resources are available. In the act of running a task, a core 110 may require new resource or a resource may become available. The core 110 running the task may check a semaphore for the resource to determine whether it is available. Core 110 may use similar criteria to those described above to determine whether a resource is available. That is, core 110 may determine that a resource is unavailable if three conditions are met: 1) the task requires a semaphore that is owned by another task; 2) the task will wait forever or for a long time to acquire the semaphore; and 3) the semaphore is a binary semaphore or mutex semaphore. If core 110 determines that a resource is now available, the method 400 may proceed to step 434. If the core 110 determines that a resource is unavailable, the method 400 may proceed to step 440. If there is no change in any required resources, the method 400 may proceed directly to step 460 without stopping any timers.

In step 434, core 110 may stop the blocked timer 215 for the task. Core 110 may subtract a system time stored in the blocked timer 215 from the current system time. Core 110 may add the difference to a cumulative blocked time for the task. The method 400 may then proceed to step 436 where core 110 may start the utilization timer 210 for the task. Core 110 may store the current system time in the appropriate entry for utilization timer 210. The method 400 may then proceed to step 460.

In step 440, core 110 may stop the utilization timer 210 for the task. Core 110 may subtract the system time stored in the utilization timer 210 from the current system time. Core 110 may add the difference to a cumulative utilization time for the task. The method 400 may then proceed to step 438 where core 110 may start the blocked timer 215 for the task. Core 110 may store the current system time in the appropriate entry for blocked timer 215. The method 400 may then proceed to step 460.

In step 450, core 110 may run the idle timer 315 for the core 110. Core 110 may store the system time in the appropriate entry of idle timer 315. In various alternative embodiments, the system 100 may treat idle time as an additional task for each core 110 and run a utilization timer 210 for the idle task when the core 110 is running the idle task. In these alternative embodiments, the idle task may be the lowest priority task and may be selected in step 430 if there are no other tasks to run. The utilization timer 210 for the idle task may start when the idle task is selected and stop when another task is selected. In either case, the method 400 may then proceed to step 460.

In step 460, method 400 begins the next cycle. Clock 115 may update the system time. The method 400 then returns to step 420 to determine whether to continue the test.

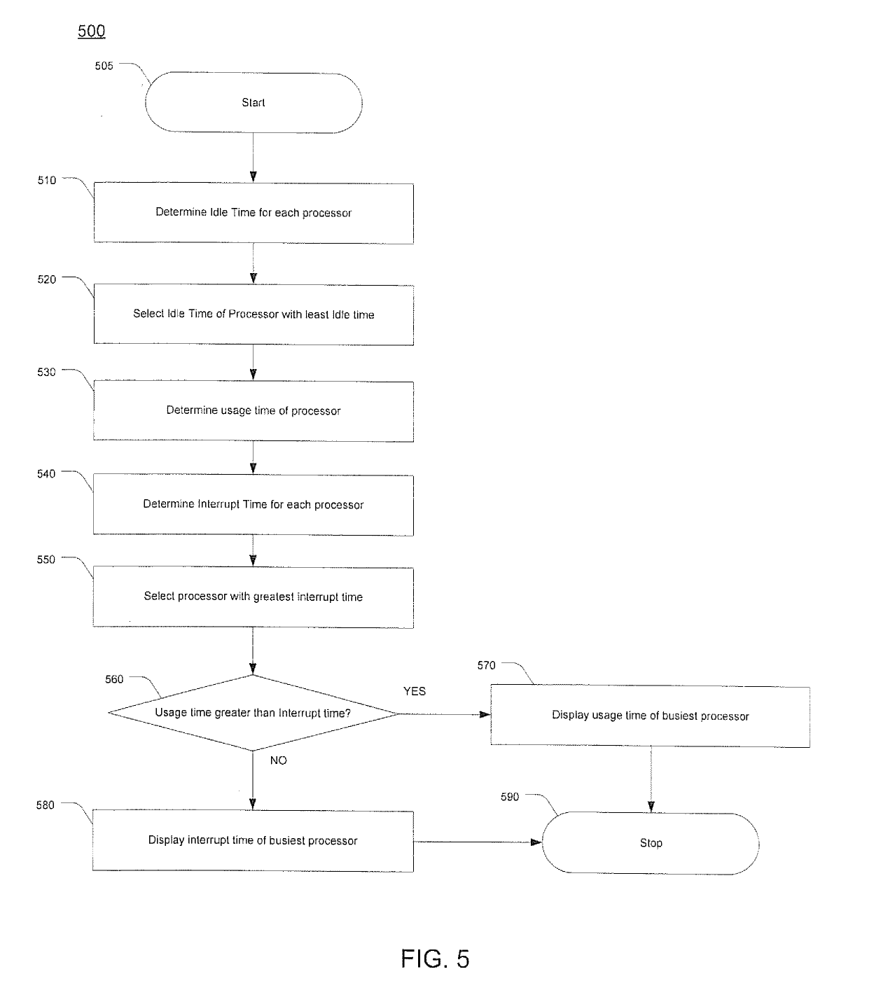

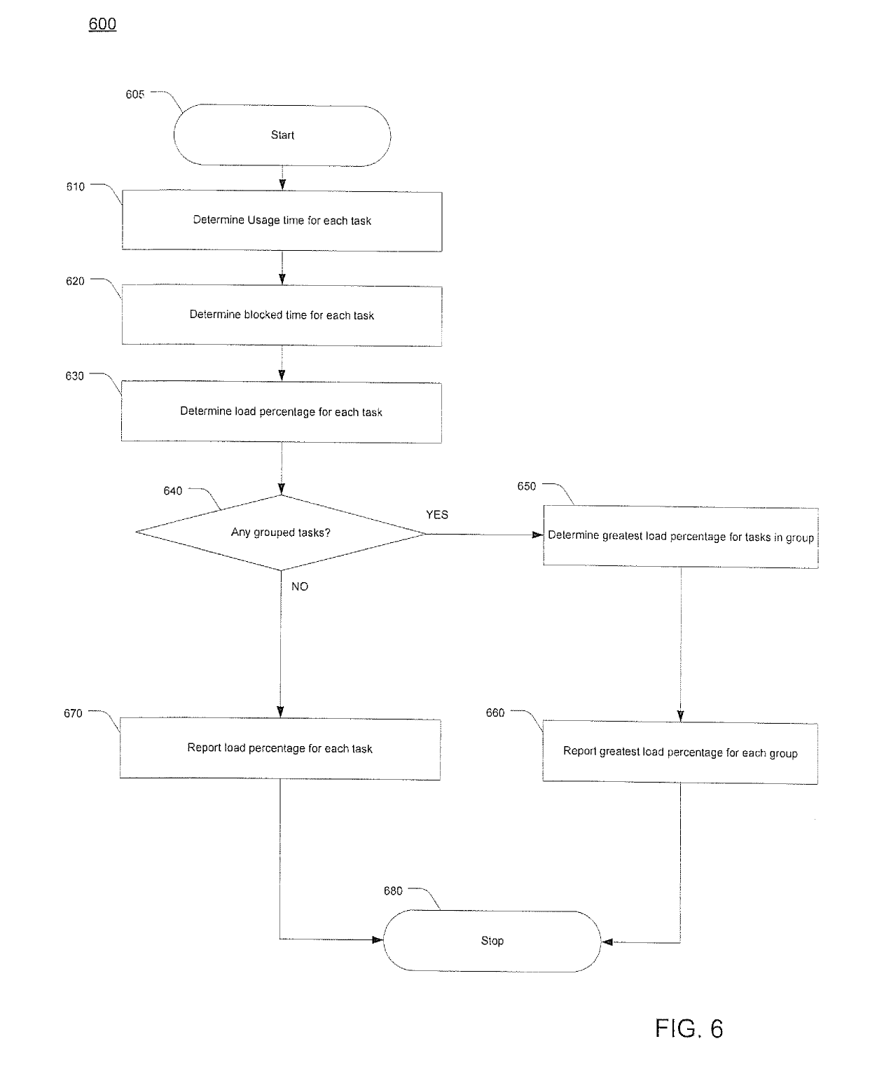

In step 470, CPU 105 may stop the test timer. CPU 105 may determine the total time of the test. The total time of the test may be different than anticipated if, for example, an interrupt request interrupts the test task. The method 400 may then proceed to step 472 where CPU 105 may calculate the test results. As described in further detail below regarding FIGS. 5-6, CPU 105 may calculate a CPU utilization and core load percentage for each task and a busiest processor utilization percentage. The method 400 may then proceed to step 474 where system 100 may display the test results to a user. Alternatively, the test results may be used by the operating system or another task. The method 400 may then proceed to step 480 where the method ends.

FIG. 5 is a flowchart illustrating an exemplary method 500 for determining the load on a busiest processor in a multi-processing system 100. Method 500 may be performed by the components of multi-processing system 100 to determine the busiest processor 110 in multi-processing system 100.

Method 500 may begin at step 505 and proceed to step 510 where CPU 105 may determine an idle time for each processor. As described above with regard to FIG. 4, system 100 may store an idle time for each processor in data structure 300 while performing method 400. CPU 105 may read the idle time for each processor from the idle timer 315 field. Alternatively, CPU 105 may read the idle time for each processor from the utilization timer 210 field of data structure 200 if the system 100 uses an idle task for each processor. Method 500 may then proceed to step 520 where CPU 105 may determine the processor with the lowest idle time by comparing the idle time of each processor 110. Method 500 may then proceed to step 530 where the lowest idle time may be converted into a utilization time for the processor. CPU 105 may convert the idle time to a percentage by dividing the idle time by the test time. CPU 105 may then determine the utilization percentage by subtracting the idle percentage from 100%. The method 500 may then proceed to step 540.

In step 540, CPU 105 may determine the interrupt time for each processor. As described above with regard to FIG. 4, system 100 may store an interrupt time for each processor in the interrupt request timer 310 field of data structure 300 while performing method 400. CPU 105 may read the interrupt request time for each processor from the interrupt request timer field 310. The method 500 may then proceed to step 550 where CPU 105 may determine the processor with the greatest interrupt request time by comparing the interrupt request time for each processor. CPU 105 may also convert the greatest interrupt request time to a percentage by dividing the interrupt request time by the test time. The method 500 may then proceed to step 560.

In step 560, CPU 105 may compare the greatest utilization percentage with the greatest interrupt percentage. If the utilization percentage is greater than the interrupt percentage, the method may proceed to step 570 where CPU 105 may determine that processor with the greatest utilization percentage is the busiest processor and report the greatest utilization percentage. If the interrupt percentage is greater than the utilization percentage, the method may proceed to step 580 where CPU 105 may determine that the processor with the greatest interrupt percentage is the busiest processor and report the greatest interrupt percentage. In various alternative embodiments, CPU 105 may use the method described above to rank the cores. In these embodiments, CPU 105 may report a utilization percentage or interrupt percentage for any number of cores. In any case, the method 500 may proceed to step 590 where it ends.

FIG. 6 is a flowchart illustrating an exemplary method 600 for determining the load percentage for each task running on a multi-processing system 100. Method 600 may be performed by the components of multi-processing system 100 to determine the load percentage for each task running on multi-processing system 100.

Method 600 may begin at step 605 and proceed to step 610 where CPU 105 may determine a utilization time for each task. As described above regarding FIG. 400, system 100 may store a utilization time for each task in data structure 200. CPU 105 may read the utilization time for each task from the utilization timer 210 field. The method 600 may then proceed to step 620 where CPU 105 may determine a blocked time for each task. As described above regarding FIG. 400, system 100 may store a blocked time for each task in data structure 300. CPU 105 may read the blocked time for each task from the blocked timer 215 field. The method 600 may then proceed to step 630 where CPU 105 may determine a load percentage for each task. CPU 105 may add the utilization time and blocked time for each task. CPU 105 may then divide the sum of the utilization time and blocked time by the test time to determine the load percentage for each task. The method 600 may then proceed to step 640.

In step 640, CPU 105 may determine whether any of the tasks are grouped. Tasks may be grouped if they belong to the same process or application. For example, an application may be optimized to use multiple tasks running parallel on different processors. CPU 105 may determine that tasks are grouped by comparing the task name or other indicator. If CPU 105 determines that there are grouped tasks, the method 600 may proceed to step 650. If CPU 105 determines that there are no grouped tasks, the method 600 may proceed to step 670 where the CPU 105 may report a load percentage for each task; then the method 600 may proceed to step 680 where the method 600 ends. In various alternative embodiments, step 640 may not occur and the method 600 may proceed directly to step 670.

In step 650, CPU 105 may determine the greatest load percentage among the tasks in each group. The method may then proceed to step 660 where CPU 105 may report the greatest load percentage for a task within each group. In this case, CPU 105 may report only one load percentage for each group. If a task is not grouped, CPU 105 may report the task individually. The method 600 may then proceed to step 680, where the method ends.

FIG. 7 is a diagram illustrating an exemplary display 700 for communicating CPU utilization to a user. Display 700 may be, for example, an image displayed on a computer monitor connected to multi-processing system 100. Display 700 may include test information 710, task information 720, and system information 740. Display 700 may present the information in a variety of forms. For example, display 700 may present information as plain text, tables, charts or graphs.

Test information 710 may provide information describing the test. Test information 710 may include a title 712 and test time 714. Title 712 may indicate that the display shows CPU Utilization test results. Test time 714 may indicate the length of time that the test measured CPU Utilization. Test information 710 may also include information such as the current time.

Task information 720 may provide information describing the tasks executed by the CPU 105. Task information 720 may include information fields for each task. Task information 720 may include task name 722, CPU time 724, CPU utilization 726, and load percentage 728. Task information 720 may also include a number of entries 730 for individual tasks or groups of tasks. Task name 722 may indicate a name for the task that a user may recognize. The task name 722 may be the name of the executable file, the name of a program, or any other name that identifies the task to a user. The task name 722 may refer to a group of related tasks. CPU time 724 may indicate the total time that the CPU 105 spent executing the task. CPU utilization 726 may indicate the percentage of total available CPU time that CPU 105 spent executing the task. If the task is a group of related tasks, CPU utilization 726 may indicate the sum of the individual percentages of total available CPU time that CPU 105 spent executing each task. Load percentage 728 may indicate total time a task spent executing or blocked on an individual processor or core. In various alternative embodiments load percentage 728 may be displayed as two separate figures: utilization percentage and blocked percentage. If the entry 730 is for a group of tasks, the load percentage 728 may indicate the maximum value for an individual task within the group. Each entry 730 may provide information for an individual task or group of tasks. The number of entries 730 may vary depending on how many tasks are executing when the test is run.

System information 740 may provide information summarizing the utilization of the system. System information 740 may include categories such as, for example, total idle 742 and busiest core 744. System information 740 may also include measurements of CPU time 746 and utilization percentage 748. Total idle 742 may describe the total resources that were unused during the test. Total idle 742 may be measured by CPU time 746 indicating the total amount of processor time spent idle. Total idle 742 may be measured by utilization percentage 748 indicating the percent of processor time spent idle. Busiest core 744 may describe the use of the most used core or processor. The busiest core 744 may be measured by CPU time 746 indicating the total time the busiest core spent executing tasks during the test. The busiest core 744 may also be measured by utilization percentage 748 indicating the percent of time the busiest core spent executing tasks during the test.

Having described exemplary components and methods for the operation of exemplary multi-processing system 100, an example of the operation of exemplary multi-processing system 100 will now be provided with reference to FIGS. 1-7. The contents of main memory 135 may correspond to data structure 200 and data structure 300. Display 700 may be an image generated by graphics card 140.

Before the process begins, multi-processing system 100 may be executing any number of tasks. The computer instructions for each task may be stored in main memory 135. Each core 110 of the CPU 105 may execute the instructions for a task. Operating system software may determine which core executes which task. When the process begins, CPU 105 may create data structures 200 and 300 in main memory 135 and initialize each timer to zero. CPU 105 may then determine the status of each task and start a timer to measure how long each task spends in the initial status. As the test runs, CPU 105 may continue to execute the tasks. When an event occurs that changes the status of a task, CPU 105 may update the timers. For example, if an interrupt occurs, CPU 105 may run an interrupt timer for a core while the core processes the interrupt. CPU 105 may also determine when a task is blocked. For example, if task 5, running on core 110c requires access to graphics card 140, core 110c may check a semaphore for graphics card 140. If task 6, running on core 110d, is using graphics card 140, task 6 will own the semaphore and task 5 may become blocked. When this occurs, CPU 105 may stop the utilization timer for task 5 and start the blocked timer. Core 110c may execute another task such as task 4, or core 110c may idle if task 4 is also blocked. When graphics card 140 becomes available, core 110c may resume processing task 5. At this time, CPU 105 may stop the blocked timer and start the utilization timer for task 5. The amount of utilization time and blocked time may be stored in entry 250. Multiple tasks may be running on multi-processing system 100, and CPU 105 may update the entry for each task as it runs.

Once the test timer indicates that the test is complete, the results may be calculated. The entries in FIG. 2 and FIG. 3 may indicate the results of a test that ran for 1 second or 1,000,000 μs. It should be noted that times may be indicated using any appropriate unit. The entries in FIG. 2 may relate to individual tasks. Entry 230 may indicate that a task named “Task 1” ran on core 0 for 50,000 μs and was not blocked. Entry 235 may indicate that a task named “Task 2” ran on core 1 for 200,000 μs and was blocked for 50,000 μs. Entry 240 may indicate that a task named “Task 3” ran on core 1 for 200,000 μs and was blocked for 50,000 μs. Entry 245 may indicate that a task named “Task 4” ran on core 2 for 200,000 μs and was blocked for 50,000 μs. Entry 250 may indicate that a task named “Task 5” ran on core 2 for 500,000 μs and was blocked for 250,000 μs. Entry 255 may indicate that a task named “Task 6” ran on core 3 for 9500,000 μs and was not blocked. The entries in FIG. 3 may relate to individual cores or processors. Entry 320 may indicate that core 0 spent 900,000 μs handing interrupt requests and 950,000 μs idle. Entry 325 may indicate that core 1 spent 50,000 μs handing interrupt requests and 450,000 μs idle. Entry 330 may indicate that core 2 spent 100,000 μs handing interrupt requests and 0 μs idle. Entry 335 may indicate that core 3 spent 20,000 μs handing interrupt requests and 50,000 μs idle.

The entries in FIG. 7 may indicate the results of the test that are displayed to a user. Test time 714 may indicate that the test ran for 1,000,000 μs. Entry 730a may indicate that Task 1 ran for 50,000 μs, which is approximately 1% of the CPU time and had a load percentage of 5%. As described above regarding FIG. 7, CPU utilization percent 726 may be based on the total CPU time rather than the test time; therefore, the 50,000 μs may be divided by 4,000,000 μs because exemplary multi-processing system 100 includes 4 processors. As described above with regard to FIG. 6, the load percentage may reflect the use of a single processor caused by utilization or blocked time, so the load percentage for task 1 may be 50,000 μs divided by 1,000,000 μs or 5%. Entry 730b may indicate that task 2 ran for 200,000 μs, which is approximately 5% of the CPU time and had a load percentage of 20%. Entry 730c may be an entry for a group of tasks including task 3 and task 4. Entry 730c may indicate that tasks 3 and 4 ran for 400,000 μs, which is approximately 10% of the CPU time and had a load percentage of 25%. In this case, the load percentage may reflect the load for task 3 including both the utilization time of 200,000 μs and the blocked time of 50,000 μs. Entry 730d may indicate that task 5 ran for 500,000 μs, which is approximately 12.5% of the CPU time and had a load percentage of 75%. In this case, the high load percentage reflects the significant time that task 5 spent blocked. Entry 730e may indicate that task 6 ran for 950,000 μs, which is approximately 23% of the CPU time and had a load percentage of 95%. This high load percentage may indicate that Task 6 is using nearly all available resources.

The entries for total idle 742 may indicate that the CPU spent 1,430,000 μs idle, which is approximately 36% of the CPU time. The entries for busiest core 744 may indicate that the busiest core spent 950,000 μs running tasks and has a utilization percent of 95%. This high utilization percent may indicate to a user that one of the cores is running near capacity. It should also be noted that although core 0 is not the busiest core and its only task has only a 5% load, core 0 also may be relatively busy because it spent approximately 90% of the time handling interrupt requests. As described above regarding FIG. 5, this interrupt percentage may have been displayed if core 3 had been less busy. In various alternative embodiments, display 700 may include additional information such as, for example, a utilization percentage for each core or any other useful statistic that may be derived from the test.

While various embodiments described herein relate to statistics gathering for multi-core systems, it should be apparent that the methods and systems may be applied to multi-processor systems with little to no modification. Accordingly, the terms “processor” and “core” should be read to refer to both individual cores in a multi-core system and individual processors in multiprocessor systems.

According to the foregoing, various exemplary embodiments provide for a method of monitoring CPU utilization in a multi-processing system. In particular, by measuring the utilization time, blocked time, interrupt request time, and idle time the method can provide meaningful statistics that allow a user to accurately judge the status of the system. The statistics may allow the user to determine whether additional resources are available and whether any tasks or cores are running at full capacity.

It should be apparent from the foregoing description that various exemplary embodiments of the invention may be implemented in hardware and/or firmware. Furthermore, various exemplary embodiments may be implemented as instructions stored on a machine-readable storage medium, which may be read and executed by at least one processor to perform the operations described in detail herein. A machine-readable storage medium may include any mechanism for storing information in a form readable by a machine, such as a personal or laptop computer, a server, or other computing device. Thus, a machine-readable storage medium may include read-only memory (ROM), random-access memory (RAM), magnetic disk storage media, optical storage media, flash-memory devices, and similar storage media.

It should be appreciated by those skilled in the art that any block diagrams herein represent conceptual views of illustrative circuitry embodying the principals of the invention. Similarly, it will be appreciated that any flow charts, flow diagrams, state transition diagrams, pseudo code, and the like represent various processes which may be substantially represented in machine readable media and so executed by a computer or processor, whether or not such computer or processor is explicitly shown.

Although the various exemplary embodiments have been described in detail with particular reference to certain exemplary aspects thereof, it should be understood that the invention is capable of other embodiments and its details are capable of modifications in various obvious respects. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

What is claimed is:

1. A method of measuring CPU utilization comprising:
executing at least one task on the CPU;
determining that a task is blocked because a resource is unavailable;
starting a first timer for the task that measures the time the task is blocked;
determining that the resource is available:
resuming processing the task;
stopping the first timer for the task; and
storing a blocked time indicating an amount of time that the task was blocked.

2. The method of claim 1, wherein the step of determining that a task is blocked comprises determining that a request for a semaphore has been denied.

3. The method of claim 2 wherein the step of determining that a task is blocked further comprises: determining that the task will wait forever for the semaphore, and determining that the semaphore is one of a binary semaphore and a mutex semaphore.

4. The method of claim 2 wherein the step of determining that a task is blocked further comprises: determining that a timeout for waiting on the semaphore exceeds a system timeout threshold.

5. The method of claim 1 further comprising:
starting a second timer that measures the utilization time of the task when the processor begins executing the task;
stopping the second timer when the task is blocked or when the processor swaps tasks; and
determining a load time by adding the blocked time and the utilization time.

6. The method of claim 5 further comprising:
determining a processor load percent for the task by dividing the processor load time by a test time; and
displaying to a user the processor load percent for the task.

7. The method of claim 6 further comprising;
determining that at least two tasks are related to the same process;
selecting from the at least two tasks a busy task with the greatest processor load percent;
displaying the processor load percent of the busy task as a processor load of the process.

8. The method of claim 6 further comprising:
determining a busiest processor among the at least two processors;
displaying a busiest processor utilization percentage to a user.

9. The method of claim 8 wherein the step of determining the busiest processor comprises:
measuring an idle time for each processor;
selecting a processor that has the lowest idle time; and
determining a utilization percentage of the processor that has the lowest idle time.

10. The method of claim 8 wherein the step of determining the busiest processor comprises:
measuring an interrupt request time for each processor;
selecting a busiest processor that has a greatest interrupt request time; and
determining a utilization percentage for the busiest processor based on the greatest interrupt request time.

11. A multi-processing system comprising:
at least two processors that execute tasks;
at least one semaphore that indicates whether a resource is available;
a first timer for each task that measures the time that the task is blocked by starting when the semaphore indicates that a resource is unavailable and stopping when one of the processors begins executing the task;
a second timer for each task that measures a utilization time for the task by starting when one of the processors begins executing the task and stops when either the semaphore indicates that a required resource is unavailable or the processor swaps tasks; and
an output device that indicates a load percentage for each task based on the sum of the time that the task is blocked and the time that the task is running.

12. The multi-processing system of claim 11, further comprising:
a third timer for each processor that measures idle time of the processor and determines an idle percentage, wherein the output device further indicates a utilization percentage of a busiest processor from the at least two processors based on the inverse of the idle percentage of the processor with the least idle percentage.

13. The multi-processing system of claim 12, further comprising:
a fourth timer for each processor that measures the interrupt request time of the processor; wherein the output device further indicates a greater of: the percentage of interrupt request time of a busiest processor from the at least two processors and the inverse of the idle percentage of a busiest processor from the at least two processors.

14. The multi-processing system of claim 11, further comprising:
a fourth timer for each processor that measures the interrupt request time of the processor, wherein the output device further indicates a percentage of interrupt request time of a busiest processor from the at least two processors.

15. The multi-processing system of claim 11 wherein the at least one semaphore is a binary semaphore.

16. A machine-readable storage medium encoded with instructions for a multi-processing system to measure CPU utilization, the machine readable storage medium comprising:
instructions for executing at least one task on a multi-processing system having at least two processors;
instructions for determining that a task is blocked because a resource is unavailable;
instructions for starting a first timer for the task that measures the time the task is blocked;
instructions for determining that the resource is available;
instructions for resuming processing the task;
instructions for stopping the first timer for the task;
instructions for reporting the time interval that the task was blocked.

17. The machine-readable storage medium of claim 16, wherein the instructions for determining that a task is blocked comprise instructions for determining that a request for a semaphore has been denied.

18. The machine-readable storage medium of claim 17 wherein the instructions for determining that a task is blocked further comprise: instructions for determining that the task will wait forever to acquire the semaphore, and instructions for determining that the semaphore is one of a binary semaphore and a mutex semaphore.

19. The machine-readable storage medium of claim 17 wherein the instructions for determining that a task is blocked further comprise: instructions for determining that the task will wait for a long time to acquire the semaphore, and instructions for determining that the semaphore is one of a binary semaphore and a mutex semaphore.

20. The machine-readable storage medium of claim 16 further comprising:
instructions for starting a second timer that measures the utilization time of the task when the processor begins executing the task;
instructions for stopping the second timer when the task is blocked or when the processor swaps tasks; and
instructions for determining a load time by adding the time that the task was blocked and the utilization time.

21. The machine-readable storage medium of claim 20 further comprising:
instructions for determining a processor load percent for the task by dividing the processor load time by a test time; and
instructions for displaying to a user the processor load percent for the task.

22. The machine-readable storage medium of claim 21 further comprising;
instructions for determining that at least two tasks are related to the same process;
instructions for selecting from the at least two tasks a busy task with the greatest processor load percent;
instructions for displaying the processor load percent of the busy task for the process.

23. The machine-readable storage medium of claim 20 further comprising:
instructions for determining a busiest processor among the at least two processors; and displaying a busiest processor utilization percentage to a user.

24. The machine-readable storage medium of claim 23 wherein the step of determining the busiest processor comprises:
instructions for measuring an idle time for each processor;
instructions for selecting a processor that has the lowest idle time; and
instructions for determining a utilization percentage of the processor that has the lowest idle time.

25. The machine-readable storage medium of claim 24 wherein the step of determining the busiest processor comprises:
instructions for measuring an interrupt request time for each processor;
instructions for selecting a busiest processor that has a greatest interrupt request time; and
instructions for determining a utilization percentage for the busiest processor based on the greatest interrupt request time.

26. A method of measuring CPU utilization in a multi-processing system, the method comprising:
starting a test timer;
measuring an idle time for each processor;
measuring an interrupt request time for each processor;
stopping the test timer;
calculating an idle percentage for each processor by dividing the idle time by the test time;
calculating an interrupt request percentage for each processor by dividing the interrupt request time by the test time;
calculating a busiest processor utilization time as the greatest of: the inverse percentage of the minimum idle percentage and the maximum interrupt request percentage; and
displaying the busiest processor utilization time.

27. A machine-readable storage medium encoded with instructions for a multi-processing system to measure CPU utilization, the machine readable storage medium comprising:
instructions for starting a test timer;
instructions for measuring an idle time for each processor;
instructions for measuring an interrupt request time for each processor;
instructions for stopping the test timer;
instructions for calculating an idle percentage for each processor by dividing the idle time by the test time;
instructions for calculating an interrupt request percentage for each processor by dividing the interrupt request time by the test time;
instructions for calculating a busiest processor utilization time as the greatest of:
the inverse percentage of the minimum idle percentage and the maximum interrupt request percentage; and
instructions for displaying the busiest processor utilization time.

28. A multi-processing system comprising:
at least two processors that execute tasks;
a first timer for each processor that measures an idle time of the processor;
a second timer for each processor that measures an interrupt request time that the processor spends handling interrupt requests; and
a output device that indicates a busiest processor utilization percentage based on a lowest idle time selected from the first timer for each processor and a greatest interrupt request time selected from the second timer for each processor.

29. A method of measuring CPU utilization in a multi-processing system, the method comprising:
executing a plurality of tasks on a plurality of processors;
measuring a utilization time for each task;
determining a processor load percentage for each task; and
displaying a processor load percentage for each task.

30. The method of claim 29, wherein the step of determining a processor load percentage for each task comprises:
measuring a blocked time for each task;
adding the blocked time for each task to the utilization time for each task; and
dividing the sum of the blocked time and utilization time by a test time.

31. A multi-processing system comprising:
at least two processors that execute tasks;
a first timer for each task that measures a utilization time for the task by starting when one of the processors begins executing the task and stops when the processor stops executing the task; and
a output device that indicates a load percentage for each task.

32. The multi-processing system of claim 31, further comprising:
a semaphore that indicates whether a resource is available; and
a second timer for each task that measures a blocked time for the task by starting when one of the semaphore indicates that a resource required by one of the processors is unavailable and stops when the semaphore indicates that the resource is available,
wherein the load percentage for each task is based on the sum of the utilization time and the blocked time for each task.
